(19) United States
(12) Patent Application Publication
(10) Pub. No.: US 2003/0121729 A1
(43) Pub. Date: Jul. 3, 2003

(54) Lift belt and system

(76) Inventors: Guenther Heinz, Wurselen (DE); Hans-Dieter Metzen, Juelich (DE)

Correspondence Address: Jeffrey Thurnau, The Gates Corporation, Mail Stop 31-4-1-A3, 900 S. Broadway, Denver, CO, 80209, US

(21) Appl. No.: 10/037,427

(22) Filed: Jan. 2, 2002

(51) Int. Cl. B66B 11/08

(52) U.S. Cl. 187/254

(57) ABSTRACT

The invention comprises a lift belt having a ribbed profile on a pulley engaging surface. The lift belt also comprises steel tensile cords within an elastomeric body. The ribbed profile engages a ribbed profile on a pulley. The lift belt exhibits increased load lifting capacity due to the increased surface area of the ribs as compared to a flat belt. The belt also comprises conductive tensile cords having a resistance. A change in resistance is used for measuring a belt condition as well as a belt load.

### FIELD OF THE INVENTION

The invention relates to a lift belt and system, and more particularly to a lift belt and system having a flat lift belt with a ribbed surface.

### BACKGROUND OF THE INVENTION

Lifting systems, including elevators, generally comprise a rope or lift belt which bears the weight of an elevator cage or other load. The lift belt is engaged in some manner with the load and a pulley or pulleys, as well as with a driver such as an electric motor.

The lift belt may comprise a flat belt. The flat belt comprises a tensile cord enclosed in an elastomeric body. The flat belt comprising a width dimension w that is greater than a thickness dimension t.

The flat belt engages lift sheaves. The lift sheaves having a flat belt bearing surface and side flanges. The lift sheaves may also comprise a rubber material on the pulley belt bearing surface.

Representative of the art is WO 99/43885 (1999) to Otis Elevator Company which discloses a tension cord for an elevator system having an aspect ratio of greater than one. The tension cord comprises a plurality of ropes encased within a common layer of coating.

Also representative of the art is WO 00/58706 (2000) to Otis Elevator Company which discloses a method and system for detecting or measuring defects in a rope having electrically conductive tension cords whereby measured resistance is indicative of defects.

The flat engagement surface on the prior art belt and pulley sheaves limit a lift torque available to lift a load. Lift torque is a function of the surface area of the belt in contact with the sheave. The flat belt sheave may also emit noise during operation. Further, the prior art ropes or belts do not comprise a jacket to reduce elastomeric body wear from contact with a system pulley.

What is needed is a lift belt having increased lift capacity. What is needed is a lift belt having ribs to engage a pulley. What is needed is a lift belt having a jacket. The present invention meets these needs.

### SUMMARY OF THE INVENTION

The primary aspect of the invention is to provide a lift belt having increased lift capacity.

Another aspect of the invention is to provide a lift belt having ribs to engage a pulley.

Another aspect of the invention is to provide a lift belt having a jacket.

Other aspects of the invention will be pointed out or made obvious by the following description of the invention and the accompanying drawings.

The invention comprises a lift belt having a ribbed profile on a pulley engaging surface. The lift belt also comprises tensile cords within an elastomeric body. The ribbed profile engages a ribbed profile on a pulley. The lift belt exhibits increased load lifting capacity due to the increased surface area of the ribs as compared to a flat belt. The belt further comprises conductive tensile cords having a resistance. A change in resistance is used for measuring a belt condition as well as a belt load.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross sectional view of the inventive belt.

FIG. 2 is a side view of a fork lift device.

FIG. 3 is a side view of an elevator system with the inventive belt.

FIG. 4 is a schematic for a resistance detecting circuit.

### DETAILED DESCRIPTION OF THE PREFERRED EMBODIMENT

FIG. 1 is a cross sectional view of the inventive belt. The belt 10 comprises tensile cords 15 encased within elastomeric body 20. The elastomeric body may comprise natural and synthetic rubbers, HNBR, EPDM, or any combinations and equivalents thereof. The tensile cords may comprise any material having a tensile strength sufficient for the intended use. The tensile cords may comprise polyester, carbon, steel, aramid, and combinations and equivalents thereof. The tensile cords comprise flexibility sufficient to allow a belt to bend to engage a pulley circumference.

The belt has a width W and a thickness t. It also comprises an aspect ratio wherein W/t is greater than one.

A pulley engaging surface 25 describes a ribbed profile. The pulley engaging surface further comprises a fiber loading. The fibers may comprise cellulose, aramid, polyester, cotton, nylon, carbon, acrylic, polyurethane, glass individually or in combination, or any other equivalent material(s) known in the art. The fibers have a length of approximately 18 μm and a thickness of approximately 15 μm in the preferred embodiment, although it is acceptable for the fibers to have a length in the range of approximately 10 μm to 30 μm and a thickness in the range of approximately 10 μm to 20 μm. The fibers are loaded in the elastomeric in an amount of approximately 25 to 30 phr with the preferred amount of approximately 28.7 phr.

The fibers extend from a belt rib pulley engaging surface. The fibers enhance an engagement friction between a belt rib and a pulley groove. They also reduce pulley engaging surface wear. They also prevent cracks from developing in the ribs during operation, thereby extending a belt life expectancy.

Belt 10 also comprises a jacket 40. Jacket 40 may comprise polyamide, polyurethane, polyethylene, woven or non-woven fabric, or any equivalent material known in the art. Jacket 40 significantly reduces wear caused by the back or flat side of the belt engaging a “back-side” pulley as described elsewhere in this specification.

In operation, the belt is self-guiding due to each rib engaging a pulley groove. The self-guiding feature eliminates the need for flanged pulleys which are otherwise required for prior art flat belts. This reduces a cost of the pulleys used in a system.

A rib angle a increases a belt rib surface engaging a pulley groove. Although the rib angle may be in the range of approximately 60° to 120°, the preferred rib angle is approximately 90° to maximize the pulley engaging surface area.

In the case of an approximate 90° rib angle, angle a increases a pulley engaging surface area by a factor of approximately √2. Increasing the belt surface engaging a pulley in this manner increases the torque which can be transmitted by a lift pulley. This in turn increases the load capacity of a lift system. Put another way, for a given load and torque the inventive belt will have a lesser width w that a prior art flat belt. This, in turn, results in a system with a reduced space requirement as compared to a prior art flat belt system.

Use of the ribs also has the desirable effect of decreasing an operating noise level as the belt engages each pulley. The use of a grooved pulley with the inventive belt also eliminates the need for a rubber coating on the pulley.

At least one of the tensile cords comprise a conductive material having a resistivity, for example steel, as well as conductive equivalents known in the art. A resistance of a tensile cord material will vary according to the load and temperature in a roughly linear manner known in the art. In ferrous materials such as steel, a change in resistance is usually proportional to a change in temperature. As a result a temperature effect is known and can be compensated, thus leaving a resistance change based upon a load to be measured.

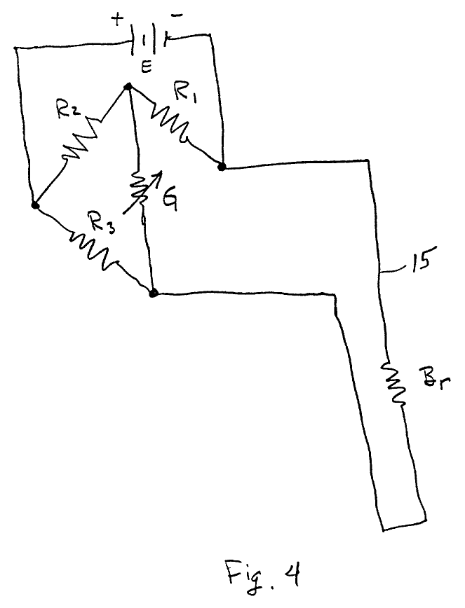

A resistance and variation in resistance may be measured on a Wheatstone bridge or other equivalent voltage bridge device, see FIG. 4. The variation is correlated to a load on the tensile cord and, in turn, the belt. This provides a measurement of a load magnitude.

For example, an operator may use this load magnitude measuring feature to control operation of a system motor and therefore of an elevator, fork lift or equivalent lift device. More particularly, if a load detecting circuit indicates an overload situation or tensile cord failure, the motor and system may be shut down, automatically or manually, for attention by an operator.

FIG. 2 is a side view of the fork lift device. The inventive belt 10 is engaged with a lift fork F.

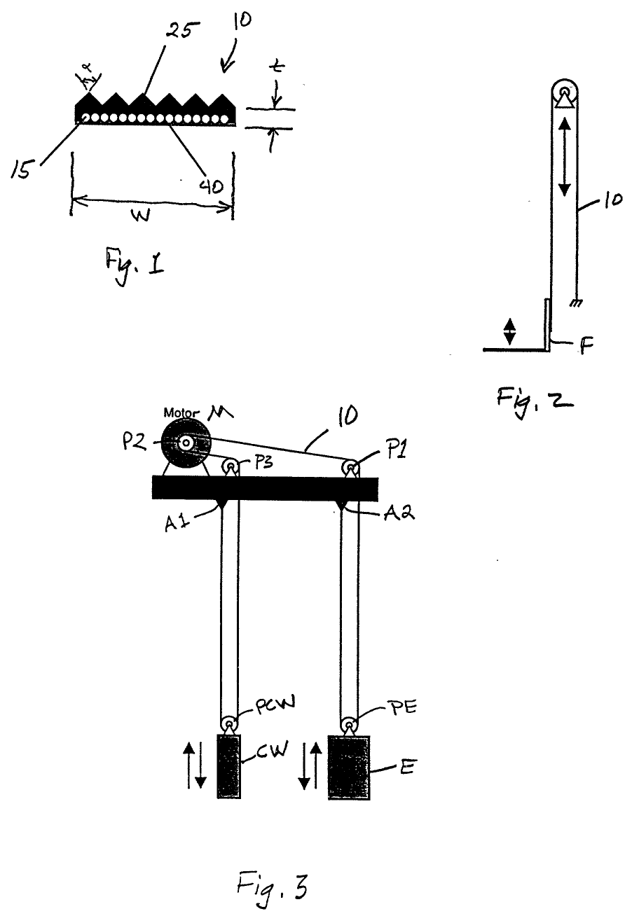

FIG. 3 is a side view of an elevator system with the inventive belt. Belt 10 is routed about a first pulley P1 to an elevator pulley PE. From PE, an end of belt 10 is connected to anchor A2. Anchor A2 may be fixed to any structural portion of a building, for example.

Belt 10 is also routed about the drive motor pulley P2 over third pulley P3 to counter weight pulley PCW. From PCW, an end of the belt 10 is connected to an anchor Al. As with A2, anchor A1 may be upon any structural portion of a building, for example.

Since the belt has a ribbed pulley engaging surface as described elsewhere this specification, pulley P1, P2, and PE are each grooved. Each of pulley P1, P2 and PE have grooves with angles of approximately 90° to receive the ribs on the belt.

Pulley P3 and PCW are also referred to as “back-side” pulleys. Each having a flat belt bearing surface since they are engaged with the flat back surface of the belt. It is upon the pulley belt bearing surface that jacket 40 is engaged. Jacket 40 significantly reduces wear of belt 10 which may otherwise be caused by operation and movement upon the pulley, thereby significantly extending an operating life.

In this embodiment belt 10 is not an endless belt. Instead, it has ends and a length. It is connected at its ends to anchor points A1 and A2. An instrument for measuring a resistance, for example an electrical circuit such as a Wheatstone bridge, is attached to a belt tensile cord at each end. This allows an entire stressed length of the belt to be monitored for a resistance change, and thereby for a load measurement. Of course, a belt failure may also be detected as evidenced by an open circuit with an approximate infinite resistance.

FIG. 4 is a schematic for a resistance detecting circuit. The circuit shown is a simple Wheatstone bridge configuration. Br is a resistance in a tensile cord 15 in belt 10. Resistors R1, R2, and R3 having resistances are known. E is a voltage source. Galvanometer G is used to indicate a null voltage such that:

Bᵣ=R1(R3/R2)

A further circuit may be connected across G to detect a magnitude of a voltage change. If a voltage change exceeds a predetermined value then a switch can be opened stopping a motor operation (not shown). For example, a voltage change of interest would include an increase to the voltage, up to and including a maximum voltage drop across R1 indicating a failure in the tensile cord.

Although a form of the invention has been described herein, it will be obvious to those skilled in the art that variations may be made in the construction and relation of parts without departing from the spirit and scope of the invention described herein.

We claim:

1. A lift belt comprising:
an elastomeric body having a width w and a thickness t and having a pulley engaging surface;
the elastomeric body having an aspect ratio w/t that is greater than 1;
a tensile cord contained within the elastomeric body and extending longitudinally;
the pulley engaging surface having a ribbed profile; and
the ribbed profile having a rib with an angle of approximately 90°.

2. The lift belt as in claim 1, wherein the tensile cord comprises a conductive material having a resistance.

3. The lift belt as in claim 2, wherein the resistance of the tensile cord varies to indicate a lifting belt load.

4. The lift belt as in claim 1 comprising a plurality of ribs.

5. The lift belt as in claim 4 having an end.

6. The lift belt as in claim 3 comprising a plurality of tensile cords.

7. The lift belt as in claim 3 further comprising:
a jacket on a surface opposite the pulley engaging surface.

8. The lift belt as in claim 7, wherein the jacket comprises nylon.

9. The lift belt as in claim 8 wherein a tensile cord comprises a metallic material.

10. The lift belt as in claim 9 wherein a tensile cord comprises steel.

11. The lift belt as in claim 1 further comprising:
an electrical circuit connected to a tensile cord for measuring a tensile cord load.

12. The lift belt as in claim 1 further comprising:
an electrical circuit for detecting a tensile cord failure.

13. An elevator lift system comprising:
a belt having an elastomeric body having a width w and a thickness t and having a pulley engaging surface;
the elastomeric body having an aspect ratio w/t that is greater than 1;
a tensile cord contained within the elastomeric body and extending longitudinally;
the pulley engaging surface having a ribbed profile;
the ribbed profile having a rib with an angle of approximately 90°; and
at least one pulley having a ribbed profile engaged with the pulley engaging surface.

14. The lift system as in claim 13, wherein the tensile cord comprises a conductive material having a resistance.

15. The lift system as in claim 14, wherein the resistance of the tensile cord varies according to a lifting belt load.

16. The lift system as in claim 13, wherein the pulley engaging surface comprises a plurality of ribs.

17. The lift system as in claim 16, wherein the belt has an end.

18. The lift system as in claim 15 comprising a plurality of tensile cords.

19. The lift system as in claim 15 further comprising:
a jacket on a surface opposite the pulley engaging surface.

20. The lift system as in claim 19, wherein the jacket comprises nylon.

21. The lift system as in claim 18 wherein a tensile cord comprises a metallic material.

22. The lift system as in claim 21 wherein a tensile cord comprises steel.

23. The lift system as in claim 13 further comprising:
an electrical circuit connected to a tensile cord for measuring a tensile cord load.

24. The lift system as in claim 13 further comprising:
an electrical circuit for detecting a tensile cord failure.

25. The lift belt as in claim 1 further comprising
fibers extending from the pulley engaging surface.

26. A lift system comprising:
a belt having an elastomeric body having a width w and a thickness t and having a pulley engaging surface;
the elastomeric body having an aspect ratio w/t that is greater than 1;
a tensile cord contained within the elastomeric body and extending longitudinally;
the pulley engaging surface having a ribbed profile;
the ribbed profile having a rib with an angle of approximately 90°;
at least one pulley having a ribbed profile engaged with the pulley engaging surface; and
an electric circuit for detecting a tensile cord load and for controlling operation of the system.

27. A method of operating a lift system comprising the steps of:
training a tensile cord over a pulley between a motor and a load;
measuring an electrical resistance of the tensile cord; and
controlling an operation of the motor according to the electrical resistance.

28. A lift belt comprising:
an elastomeric body having a width w and a thickness t and having a pulley engaging surface;
the elastomeric body having an aspect ratio w/t that is greater than 1;
a tensile cord contained within the elastomeric body and extending longitudinally;
the pulley engaging surface having a ribbed profile; and
the ribbed profile having a rib with a rib angle.

29. The lift belt as in claim 28, wherein the tensile cord comprises a conductive material having a resistance.

30. The lift belt as in claim 29, wherein the resistance of the tensile cord varies to indicate a lifting belt load.

31. The lift belt as in claim 28, wherein the rib angle is in the range of approximately 60° to 120°.

32. The lift belt as in claim 28, wherein the rib angle is approximately 90°.
